(19) United States
(12) Patent Application Publication
(10) Pub. No.: US 2008/0022301 A1
(43) Pub. Date: Jan. 24, 2008

(54) PLACING TELEVISION COMMERCIALS INTO AVAILABLE SLOTS ON MULTIPLE TELEVISION STATIONS

(76) Inventor: Stavros Aloizos, Ardsley, NY (US)

Correspondence Address: PROSKAUER ROSE LLP;PATENT DEPARTMENT, 1585 BROADWAY, NEW YORK, NY, 10036-8299, US

(21) Appl. No.: 11/765,846

(22) Filed: Jun. 20, 2007

Related U.S. Application Data
(60) Provisional application No. 60/805,283, filed on Jun. 20, 2006.

(51) Int. Cl. H04N 7/10

(52) U.S. Cl. 725/34

(57) ABSTRACT

Described herein is technology, e.g., systems, devices, and/or software, for matching available advertisements to unused advertising space for television programming. In some implementations, advertisers post the commercials that they want to run, and stations post the time slots that have not yet been sold to advertisers. Asking prices for the stations' time slots are compared with the price offered by the advertiser for running the commercial, selection criteria of both the advertiser and the station are compared, and commercials that need to be run are matched with the unsold time slots. Data necessary to run the commercials that have been matched is routed between the advertisers and stations.

### CROSS-REFERENCE TO RELATED APPLICATIONS

This application claims priority to and the benefit of, and incorporates herein by reference in their entirety, provisional U.S. patent application Ser. No. 60/805,283 filed Jun. 20, 2006.

### FIELD OF THE INVENTION

The present invention relates generally to advertising and, more specifically, to matching available advertisements to unused advertising space for television programming.

### BACKGROUND

Television advertisers that want to run a commercial for a given product have to contact many television stations individually and arrange for the television stations to run the advertiser's commercial. Similarly, media sellers at each television station have to interact with many individual advertisers to sell the seller's station's advertising spots. Often, sellers are unable to sell 100% of the advertising spots on any given day. Since the unsold spots expire as soon as the time slot has passed, this failure to sell all available spots is a missed opportunity to realize revenue.

### SUMMARY OF THE INVENTION

Described herein is technology, e.g., systems, devices, and/or software, for matching available advertisements to unused advertising space for television programming. In some implementations, advertisers post the commercials that they want to run, and stations post the time slots that have not yet been sold to advertisers. Asking prices for the stations' time slots are compared with the price offered by the advertiser for running the commercial, selection criteria of both the advertiser and the station are compared, and commercials that need to be run are matched with the unsold time slots. Data necessary to run the commercials that have been matched is routed between the advertisers and stations.

In some implementations there is a method for matching television advertisements to unused television advertising space. The method includes receiving, from an advertiser, a television advertisement, a price offered associated with the advertisement, and a first rate-determinative data. The method also includes receiving, from a television station, a time slot that has not yet been sold, an asking price associated with the time slot, and a second rate-determinative data. The time slot and advertisement are matched based on a weighted budget based on the time slot, the offered price, the asking price, and a comparison between the rate-determinative data of the advertiser and the rate-determinative data of the television station. Once matched, a confirmation, e.g., ratings information, show information, date and/or time information related to running the commercial, price, length of commercial unit, or any combination thereof and the like, is sent to the advertiser. Traffic data, which includes the advertisement and the time slot, is sent to the television station.

In some implementations there is a system for matching television advertisements to unused television advertising space. The system includes one or more computer servers. A first computer server is configured to receive, from an advertiser, a television advertisement, a price offered associated with the advertisement, and a first rate-determinative data. A second computer server is configured to receive, from a television station, a time slot that has not yet been sold, an asking price associated with the time slot, and a rate-determinative data. A third computer server is configured to match the advertisement with the time slot based on a weighted budget based on the time slot, the offered price, the asking price, and a comparison between the rate-determinative data of the advertiser and the rate-determinative data of the television station. There is also a fourth computer server configured to send a confirmation, e.g., ratings information, show information, date and/or time information related to running the commercial, price, length of commercial unit, or any combination thereof and the like, to the advertiser. Traffic data, which includes the advertisement and the time slot, is sent to the television station by the fourth server. In some implementations, the first, second, third, or fourth computer servers are the same computer server, performing multiple tasks in the system.

In some implementations, there is software, e.g., a computer program product, tangibly embodied in a computer-readable medium, for matching television advertisements to unused television advertising space. The software includes instructions operable to cause a data processing apparatus, e.g., a computer, to receive, from an advertiser, a television advertisement, a price offered associated with the advertisement, and a first rate-determinative data. The software is also operable to cause a computer to receive, from a television station, a time slot that has not yet been sold, an asking price associated with the time slot, and a second rate-determinative data. The software is further operable to cause a computer to match the advertisement with the time slot based on a weighted budget based on the time slot, the offered price, the asking price, and a comparison between the rate-determinative data of the advertiser and the rate-determinative data of the television station. The software also causes the computer to send a confirmation, e.g., ratings information, show information, date and/or time information related to running the commercial, price, length of commercial unit, or any combination thereof and the like, to the advertiser. Traffic data, which includes the advertisement and the time slot, is sent to the television station.

In any of the foregoing, rate-determinative data includes one or more of a number of impressions (e.g., the number of people of a particular demographic that will potentially see a presented commercial), a geographic location, a CPM value, a television show, a television channel, a television network, a day part, or any combination thereof. In any of these implementations the traffic data may further include the price paid for the advertisement to run during the time slot.

In one implementation there is a method for matching advertisement copy to unused advertising inventory of a television station. The method includes receiving a parameter associated with the copy from an advertiser. In some embodiments, the parameter is a price offered to display the copy at a particular time. The method also includes receiving a parameter associated with the inventory from a television station, the parameter often being a price requested to display copy at a particular time. The method continues by determining a designated market area price check. The inventory is summarized and a budget is determined (the budget being associated with the copy) based on the parameter received from the advertiser. The method also determines a weight associated with the television station based on the parameter. The method also determines a weight associated with the television station based on the budget. A third weight is determined, the third weight being associated with the inventory based on the weight associated with the television station based on the budget. Lastly the copy and inventory are matched based on the first and third weighted values. Systems and software (computer program products tangibly embodied in a computer-readable medium) are typical means of processing and performing the method.

In some embodiments, the television station is multiple television stations, a regional operator, or a multi-system operator. In some of these embodiments the matching is performed iteratively and automatically for the plurality of television stations.

In one implementation, a web based interface allows advertisers to establish criteria for an advertising campaign through the campaign manager user interface. On a weekly (or daily basis), a media seller such as a cable multiple system operator (MSO) sends a data feed, e.g., an extensible markup language (XML) file, to a system, implementing the technology. In some implementations, the data feed includes information on the media seller's sold and unsold advertising inventory for the media properties the seller is responsible for, e.g., national, regional, and/or local cable systems. In some implementations, the inventory described in the XML file is parsed to determine the actual inventory availability by day, day part, program, network, etc. The technology then determines a rate, e.g., a dollar amount that is charged for placing the advertisement, by matching the inventory with the corresponding ratings data, e.g., Nielsen data or historical rate data. The technology then matches advertiser profiles to the available inventory, and generates an export file feed, e.g., an XML file. In some implementations, the export feed includes contract information, trafficking data, and commercial copy. The export is then typically sent to the media seller.

Prior to delivering the inventory file, the media seller has the ability to login using a broadcast dashboard user interface to approve or decline an advertiser, an advertising agency, a product, or creative based on standards and practices, i.e., the governing body at a station that ensures content does not violate public policy and/or indecency practices enforced by the Federal Communications Commission (FCC). Additionally, the media seller may turn on/off day parts that the system can match, and turn on/off particular networks or regions. This prevents the placement of orders on prohibited programming. Using the broadcast dashboard, the media seller can also control and determine the rate “floor,” i.e., the lowest amount the media seller is willing to accept, based on CPM, i.e., cost per thousand listeners/viewers, or other value measure.

Other aspects and advantages of the present invention will become apparent from the following detailed description, taken in conjunction with the accompanying drawings, illustrating the principles of the invention by way of example only.

### BRIEF DESCRIPTION OF THE DRAWINGS

The foregoing and other objects, features, and advantages of the present invention, as well as the invention itself, will be more fully understood from the following description of various embodiments, when read together with the accompanying drawings, in which:

FIG. 1 is a flowchart depicting one implementation of SWMXTV;

FIG. 2 is a block diagram depicting the dataflow during a matching operation whereby the implementation selects the advertisement that will be assigned to a time slot;

FIG. 3 is a chart depicting an advertiser's desired day part and associated price the advertiser is willing to pay as well as a network's available day parts and the associated asking price;

FIG. 4 is a flowchart depicting how a copy budget is determined based on the Type of Budget;

FIG. 5 is a block diagram depicting a product budget calculation;

FIGS. 6A through 6L depict screenshots describing functionality available to a media seller in some implementations for the technology, whereby users can add, delete, and manage users, advertisers, and copy; and

FIGS. 7A through 7O depict screenshots describing functionality available to an advertiser; and

FIG. 8 depicts a dataflow during the retrieval of approved copies, Designated Market Area (DMA) price checks, and inventory summarization described with respect to FIG. 2.

### DETAILED DESCRIPTION

Matching available advertisements to unused advertising space for television programming is difficult. Individual media sellers (such as cable MSOs) typically contact individual advertisers to provide time slots media sellers have available and negotiate the pricing advertisers are willing to pay to have advertisements run in those time slots. Since unsold spots expire as soon as the time slot has passed, failure to sell all available spots is a missed opportunity to realize revenue. The present invention facilitates the matching of advertisements to time slots and negotiation between advertisers and media sellers. By way of example, one implementation of the invention is the website SWMXTV and is used herein as an example. The implementation is an example only and does not limit the spirit or scope of the invention.

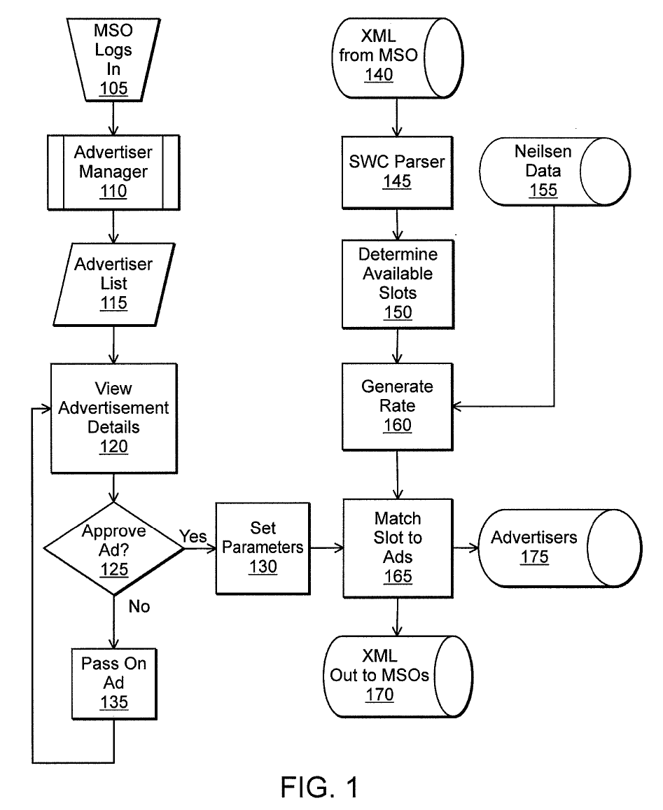

FIG. 1 is a flowchart depicting one implementation of SWMXTV. For simplicity's sake, a cable MSO is used throughout as an example of a media seller, but the described technology is applicable to negotiating time slot availability and price between any advertiser and media seller, e.g., cable MSOs, radio stations, and the like. In FIG. 1, the MSO logs into 105 SWMXTV. The MSO accesses 110 the advertiser manager and then access 115 the advertiser list. The MSO is then able to view 120 the details of the advertisements each advertiser is asking to run. If MSO's approves 125 the advertisement, the MSO sets 130 the parameters for the advertisement such as price and/or data about the commercial itself, e.g., duration, target demographic, preferred run time, preferred day part, and the like. If the advertisement is approved, a flag is set by SWMXTV. If the advertisement is not approved, the advertisement is passed on 135 and the next advertisement is reviewed 120 for approval. This approval process occurs for one or more, or optionally all, advertisements available for a given advertiser and may involve reviewing ads for multiple advertisers.

Before, during, or after the MSO logs in, SWMXTV receives 140 an XML file from the MSO listing the available time slots the MSO desires to fill. Software parses 145 the XML file, e.g., separating the XML file into its elements and attributes. SWMXTV then determines 150, based on the parsed information, the available time slots the MSO desires to fill and what channels those time slots appear on. Before or during determining step, SWMXTV receives 155 demographic data from Nielsen Media Research (a Nielsen Company). The Nielsen data includes information such as how many people are watching a particular show, demographic data for the people, e.g., family size, gender, race, etc., and increases or decreases in the number of viewers for a particular time slot/channel since a previous measurement. Based on the Nielsen data and the time slots available to the MSO, a rate to be charged for placing an advertisement at a particular time is calculated 160 based on supply and demand, demographic that is being targeted, day part, number of impressions, and the like. Based on the rate the MSO prefers to charge for running a particular advertisement at a particular time, SWMXTV matches 165 the available time slots with the available advertisement. An XML file is then generated and sent 170 to the MSO describing the order that was placed, e.g., identifying the commercial to be run and the time. Typically this file, or a converted version of the file, is then sent to the MSO. The MSO will then log in an retrieve the commercial to import the commercial into the MSO's system for running at the appropriate time or, alternatively, the MSO can pull the commercial from the SWMXTV site into the MSO's traffic and/or inventory system. Additionally data that the advertisement will run at a specified time or during a specified day part is generated and sent 175 to the advertisers.

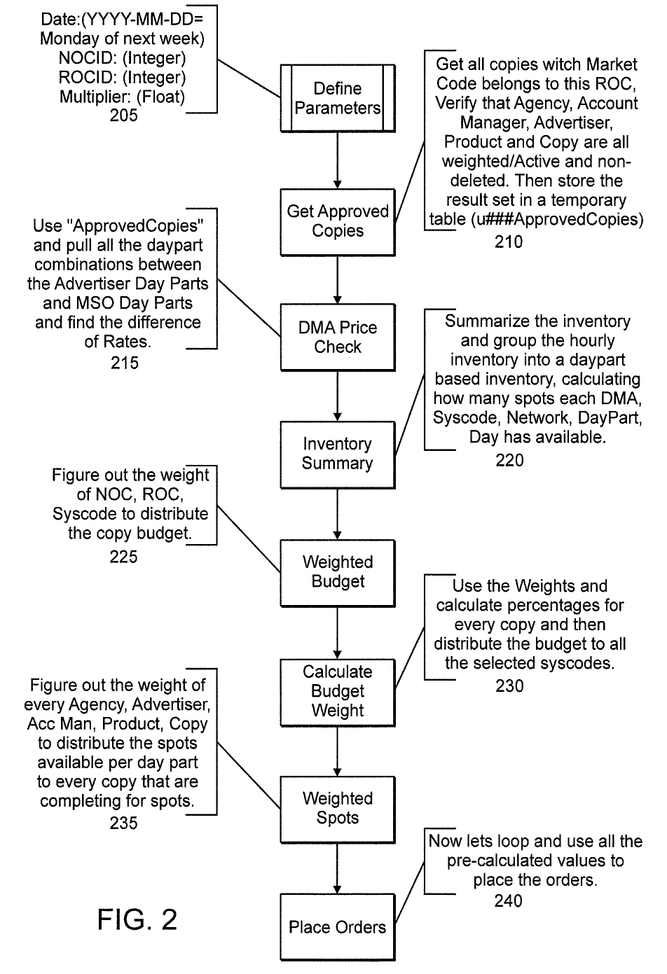

FIG. 2 a block diagram depicting the dataflow during a matching operation whereby the implementation selects the advertisement that will be assigned to a time slot. In some implementations the matching is done on a first-come-first served model wherein the first advertisement that matches the time slot based on the demographic information and pricing is accepted. In some implementations, an iterative-highest-price matching scheme is used wherein the advertisements for the same time slot are considered and the advertisement with the highest offered price is selected. The matching scheme may be run again before the actual time slot occurs and if a different advertisement is offered for a higher price, the new advertisement is run at that time slot instead of the earlier-selected advertisement, thereby maximizing the revenue received per time slot.

The following is an example of data and functionality of one implementation (SWMXTV.com) of the technology described herein from both the advertiser's standpoint of using the system and the cable MSO's standpoint. Setting up the advertisers and MSOs (often using advertiser and MSO initialization modules respectively) encompasses defining the parameters (step 205) used by SWMXTV.com.

Advertiser Perspective

Once the advertiser has registered with SWMX, a representative enters the preset values that allow the advertiser to use the SWMX Platform, e.g., SMWXTV.com website. For example, the representative provides:

| Value | Description |
|---|---|
| Name | The Name that identifies the agency on the |
| | platform. |
| Contact Info | The information for the person that is |
| | responsible for the agency's account. |
| StandBy Campaign | This value is used as a preset to create any |
| Commission | advertisers under the selected agency. |
| StandBy Campaign | This value is used as a preset to create any |
| Transaction Fee | advertisers under the selected agency. |
| Flighted Campaign | This value is used as a preset to create any |
| Commission | advertisers under the selected agency. |
| Flighted Campaign | This value is used as a preset to create any |
| Transaction Fee | advertisers under the selected agency. |

After creating an agency, an account manager is created. The account manager is the member of the agency that manages the advertisers. Next, an advertiser is created. Though many parameters are available, only exemplary values are presented to explain the advertiser creation and the transaction of a copy. The values typically used in creating an advertiser are:

| Value | Description |
|---|---|
| Agency | Select an agency from the drop down menu if is |
| | not already selected by default. |
| Account Manager | Select an account manager that controls and |
| | manage this advertiser. |
| Advertiser Name | The name that identifies the advertiser on the |
| | platform. |
| Advertiser Code | This is a code that is used to generate a unique ID |
| | for every media file that is attached to a copy. |
| Contact Info | The information of the person that is directly |
| | responsible for this advertiser. |
| StandBy Campaign | This value is used as a preset to create any copies |
| Commission | under the selected advertiser. |
| StandBy Campaign | This value is used as a preset to create any copies |
| Transaction Fee | under the selected advertiser. |
| Flighted Campaign | This value is used as a preset to create any copies |
| Commission | under the selected advertiser. |
| Flighted Campaign | This value is used as a preset to create any copies |
| Transaction Fee | under the selected advertiser. |

After creating an agency, an account manager, and an advertiser, they are weighed. Any of the foregoing can be weighed individually and distribute their percentages against other agencies, account managers and/or advertisers. These weights are useful when distributing inventory from multiple copies that belong to multiple advertisers. Once the agencies, account managers and/or advertisers are configured correctly, campaigns are created.

Creating a Campaign

Typically the first part of creating a campaign is creating a product. On the first tab the advertiser is presented the following fields:

| Value | Description |
|---|---|
| Product Name | The name of the product that the advertiser is |
| | going to plan. |
| Overall Budget | This is the overall budget that the advertiser |
| | intends to spend for this product. This also limits |
| | the amount of money that each copy under this |
| | product is going to spend. |
| Weekly Budget | This value limits the amount of budget spent |
| | weekly for all stand by campaigns. |
| Type of Budget | This is where the advertiser decides how the |
| | money is distributed across the length of the |
| | campaign. |
| | Overall Budget - This budget is spent in its |
| | entirety as soon as possible. |
| | Weekly Budget - This budget spends the amount |
| | entered on a per week basis. |
| | Copy Budget - This budget uses the actual |
| | budget value defined to limit the amount of |
| | money that is spent for this copy. |
| Transaction Fee | This is a value that is set as the default value for |
| | any new copies created under this product. |

In some implementations, the information on the product level is used as a template for the copies that are created under it. After the product is created, copy is created. The copy contains the main campaign information. The advertiser can narrow the buy and pick the day parts that the advertiser is willing to buy using the cost projections. On the first tab the advertiser is typically presented the following fields:

| Value | Description |
|---|---|
| Copy Name | This is the name of the copy that the advertiser is |
| | going to plan. |
| Type of Broadcast | In this field the advertiser selects the type of |
| | network the advertiser wants to reach (Cable or |
| | Broadcast Stations). |
| Copy Budget | This is typically used when product's Type of |
| | Budge is set to copy budget. |
| Transaction Fee | This value is used to charge a transaction fee for |
| | every copy ran through the platform. In some |
| | implementations this value is ignored based on the |
| | advertiser's arrangement with SWMX. |
| ADID | This is a number that is composed of the Agency |
| | Code and a unique number. This number is used to |
| | track the media file. |
| Time Slot | This value is based on the length of the spot. |
| | Accordingly, a percentage value that decreases or |
| | increases the rate proportionally to the length of |
| | the spot. |

On the Second tab “Copy Placement” the advertiser is presented with the following fields:

| Value | Description |
|---|---|
| Start Date | The date that the campaign begins |
| End Date | The date that the campaign ends. |

Typically, demographics are used to calculate cost projections and generally do not affect how the spots are distributed. Markets are typically provided to help the user narrow the search and select the day parts on the next screen. The third tab is “Copy Schedule”. These values are used to help the user narrow their campaign.

If the advertiser is not presented with the screen explained above, then the advertiser is presented a grid that allows the advertiser to navigate through the selected markets, networks, days, and day parts selected previously. Each line item “Day Part” is used to place the order. The advertiser can navigate through the options and change the values based on the advertiser's goals. After setting the advertiser's min/max spots and rate, the advertiser continues to the next tab entitled “Campaign Copy Preview”. On the Campaign Copy Preview page the advertiser is presented a summary of the campaign in a grid format. The data represented on the grid is typically compared to the inventory of the selected stations. On a PDF preview print, the transaction and commission values are used to represent the surcharges and how the total media cost is distributed. In most implementations, it is assumed that each station/network that the advertiser selected under the markets have rate cards set by every Broadcaster/Multi-System Operator (MSO)/Inter-Connect.

MSO/Station Perspective

First, either an MSO or a broadcaster is created, depending on who will access the system and run commercials. Typically using the following information is used for either:

| Value | Description |
|---|---|
| Name | Name of the MSO or Broadcaster. |
| Contact Info | Information for the person responsible for the |
| | MSO account. |
| Weight | The weight assigned to the MSO or Broadcaster |
| | used in determining distribution of an advertising |
| | budget allocated to the MSO |
| StandBy Campaign | This value is used as a preset and applied to any |
| Commission | copies under the selected advertiser. |
| StandBy Campaign | This value is used as a preset and applied to any |
| Transaction Fee | copies under the selected advertiser. |
| Flighted Campaign | This value is used as a preset and applied to any |
| Commission | copies under the selected advertiser. |
| Flighted Campaign | This value is used as a preset and applied to any |
| Transaction Fee | copies under the selected advertiser. |

Depending on if the created entity is an MSO or a Broadcaster, slightly different workflows are followed. After creating the MSO, a Regional Operational Center(s) (ROC) is created using the same process that was used to create a MSO. Once a ROC is created, stations and/or networks are also created. In some implementations, MSOs contain multiple system codes (syscodes) under each ROC for each network. The MSO then distributes weights among the available ROCs.

If a broadcaster was created rather than an MSO, then a station is created rather than a ROC. Typically a broadcaster has a single syscode for each station. Because the weight assigned to a syscode for a broadcaster is not distributed between multiple syscodes, the default weight is set to 100%.

After creating a ROC or a Station typically every level is weighed on this section (e.g., MSO/broadcaster, ROC, and network/station). Here the different workflows for MSOs and broadcasters combine and are equivalent. The term MSO is used now to encompass both MSOs and broadcasters.

In some implementations, a rate card for every network/station is added to the system. Adding the rate card is typically done through the rate manager interface. To access the rate manager interface, the MSO, while on the station Dashboard, selects “Add/Edit Rate Cards.” The MSO navigates through the grid and selects the desired network/station. When the flash calendar loads, the MSO selects “Add Day Part/Broad Rotator”. Then the MSO follows on-screen instructions (not shown) to fill up each Day Part.

In some implementations, typical values of a day part rate cards include:

| Value | Description |
|---|---|
| Start Date/Time | Range in which the rate card is reflected across |
| | multiple months, weeks, or days during a specific |
| | time range. |
| Rate | Full rate of this day part. |
| Percentage % | Percentage of the full rate that the station is willing |
| | to accept. |
| | Note: Typically Used for remnant inventory. |
| Standby Rate | Full rate with the percentage applied. This value is |
| | used to match against the advertiser campaigns. |
| | Note: Typically there is a multiplier applied to this |
| | and is not shown at the station. |

Typically each rate is at the syscode level, but the advertiser places business at the Designated Market Area (DMA) level. This means that the DMA rate is an aggregate of generally all the syscodes inside that market/DMA.

After creating the rate cards, an advertiser is able to create a campaign using the steps described above. Once the advertiser is done creating their campaign, the station or ROC provides their inventory either by importing a data feed or manual entry into a system implementing the described technology. Typically the available spots are provided for the upcoming week for each day part that you have specified.

In some implementations, the inventory entered into the platform is entered in hourly intervals. In those implementations, if the inventory is supplied as day parts or an aggregate of a time range, it is often difficult for the system to place spots. The difficulty arises because copies can conflict or overlap with one or more day parts. In these scenarios, the system picks the lowest rate that matches the campaign selected. By providing the inventory hourly, the overlapping day part is beneficially narrowed to only one hour, instead of a period of greater time.

Once the campaigns have been created and copies entered, an MSO is able to preview the copies waiting in the queue for approval. The MSO can then approve the content of the copy based on several factors, e.g., complying with standards and practices. After approving the copies, the technology then analyzes at the spread and reviews the differences between rates that the advertiser is offering and what the MSO was asking for a particular day part. If an MSO is willing to accept less money than what is offered for a particular spot, the spread is updated. Once the above has been completed, the technology iteratively and automatically matches the unsold inventory with copy (e.g., an advertisement).

During the matching process, the values previously provided (step 205) by both the advertisers and the MSOs are evaluated and the technology matches the spots across the selected criteria for all the campaigns that the platform has on the queue for a particular ROC or station so that the copies can be approved (step 210). The collection of the approved copies is performed by a copy-retrieval module. The module begins by retrieving all the copies that belong to this ROC/Station and NOC (National Operations Center) (MSO/Broadcaster) where the copies have been approved, e.g., where the values of each variable match the corresponding values in the following table:

| Variable | Value |
|---|---|
| NOC | is Active |
| | is not deleted. |
| | is weighted and its weight is not zero. |
| ROC | is active |
| | is not deleted |
| | is weighted and its weight is not zero |
| Syscodes | The syscode has a value called “price percent” |
| | and typically contains a numeric value that |
| | represents how big the syscode is based on |
| | the quantity of house holds that the |
| | DMA contains. |
| | This value is generally greater than zero. |
| | Also the variable “use” is generally equal to 1. If |
| | the use variable is not equal to 1, then the syscode |
| | is disabled. |
| SubCampaigns | Get all the copies where the Start Date and End |
| | Date falls into the next week first Monday until |
| | the following Sunday. |
| SubCampaignDetails | Get all selected day parts are part of the copies |
| | and also belongs to the respective Market that is |
| | composed of all the syscodes. |
| Copy Approval | Copies that were approved by the ROC or Station. |
| | is Approved |
| | is previewed |
| Copies | is Active |
| | is not deleted |
| | is weighted and it's weight is not zero |
| Products | is Active |
| | is not deleted |
| | is weighted and it's weight is not zero |
| Advertiser | is Active |
| | is not deleted |
| | is weighted and it's weight is not zero |
| Account Manager | is Active |
| | is not deleted |
| | is weighted and it's weight is not zero |
| Agency | is Active |
| | is not deleted |
| | is weighted and it's weight is not zero |

After this information is captured, it is determined how much budget the Advertiser has available to spend for every set of Copies that will run.

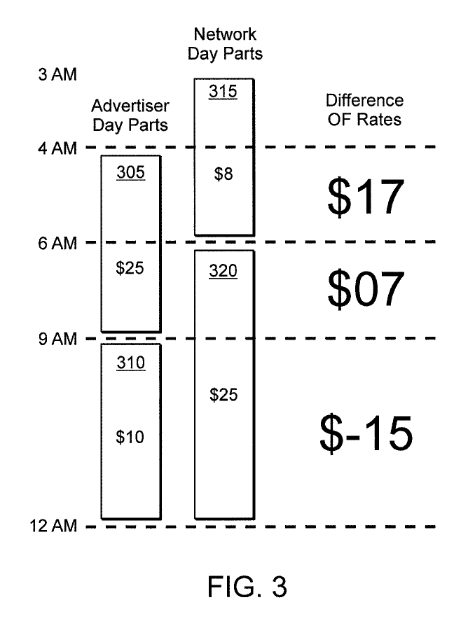

As part of the matching process, a DMA price check is performed (step 215) by a DMA price-checking module. The information from the approved copies is matched against the DMA rates from the networks/stations. Typically the day parts of the copies do not have the same time periods as the network/station DMA rates do. Referring to FIG. 3, for example, desired day parts for copy may be 4 AM to 9 AM (305) and 9 AM to 12 PM (310) whereas one network may have a day part of 3 AM to 6 AM (315) and a second day part of 6 AM to 12 PM (320). Thus it is, in some cases, difficult to match copy day parts with available day parts. The difficulty is compounded when additional networks are considered. For example, assume another network (not shown) has first day part of 5 AM to 10 AM and a second day part of 10 AM to 12 PM. As the number of networks that are considered for placing an advertisement increases, the difficulty of placing advertisements effectively to maximize both return-for-the-cost for advertisers and space-filled-per day part for MSOs also increases. Additionally, in some implementations, the rates fluctuate based on day part, network, time slot, show, combination of these and the like. In FIG. 3, a rate for the 3 AM to 6 AM day part (315) for the network shown is $8 whereas the rate for the 6 AM to 12 PM day part (320) is $25. Rates, however, are generally not simple dollar amounts arbitrarily assigned. Rates are based on the potential impressions (i.e., viewers) based on factors such as day part, demographic, time slot, television show airing, combinations of these, and the like and may not be the same based on these factors. For example, the rate of $8 for the 3 AM to 6 AM day part (315) may be based on attempting to reach 5000 males aged 18 to 34 years old. The same day part (315) when trying to reach 5000 males aged 35 to 45 years old may be $12 because more 35 to 35 year old males are watching television at that time, or that particular channel, or a particular show on that channel, and thus the space is more valuable when considering that demographic.

Still referring to FIG. 3, an advertisement is typically placed only at a spot where the difference in rates is greater than zero. Beneficially when the difference is greater than zero, the money left over from purchasing a spot in the inventory is then distributed proportionally across the syscodes that conform to the desired DMA. After the price check across all the DMA(s) is performed the technology removes all the day parts where the Difference of Rate was less than zero.

Referring back to FIG. 2, after the DMA price check (step 215), the remaining inventory is summarized (step 220). During inventory summarization (step 220), the technology takes the inventory for the next week and groups it, adding the amount of available spots, the amount of spots sold, and the total for every day part time frame combination found during the DMA price check. The inventory summarization (step 220), however, is not at the DMA level. Instead a combination of day parts at the syscode level and with their spot aggregates is considered. This process (step 220) is processed by an inventory summarization module.

With the data at the syscode level, the rates for every combination of day parts are determined. As described in the DMA price match, in some implementations there are day parts where additional money is unspent. In these scenarios, the left over money is distributed at the syscode level, the difference proportionally based on the original syscode rate. Beneficially, the weights assigned during the creation of the ROC/MSO/broadcaster are used to weigh the copy budget (step 225) in some implementations to determine what percentage of the money is spent on each syscode. This process is determined by a budget-weighing module.

Based on the percentages, the inventory is re-examined automatically during a budget weight calculation (step 230) to see if every day part at the syscode level has spots available in the inventory those spots are not counted when distributing the money across the syscodes. Additionally, the amount of money that each copy is able to spend for the campaign based on its type is locked. If the type of budget is Copy Budget then the system uses that copy budget to limit how much can be spent on that copy. This process is determined by an accounting module.

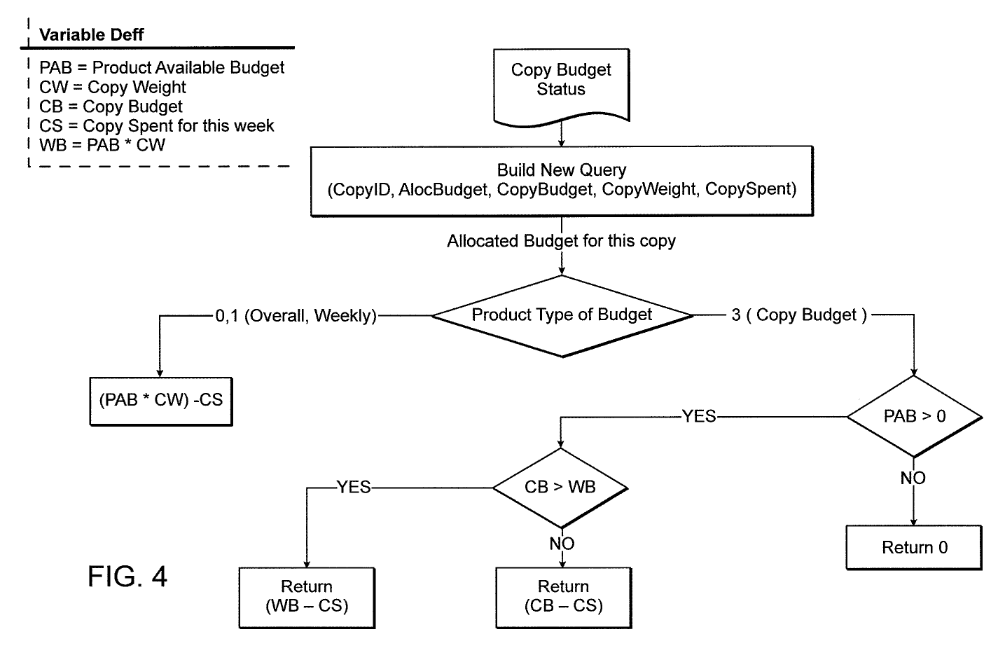

How the Copy Budget is determined based on the Type of Budget is depicted in FIG. 4. In some implementations, based on the available budget, the process described above is iterated over (potentially multiple times) and advertisements are placed until the available budget is depleted.

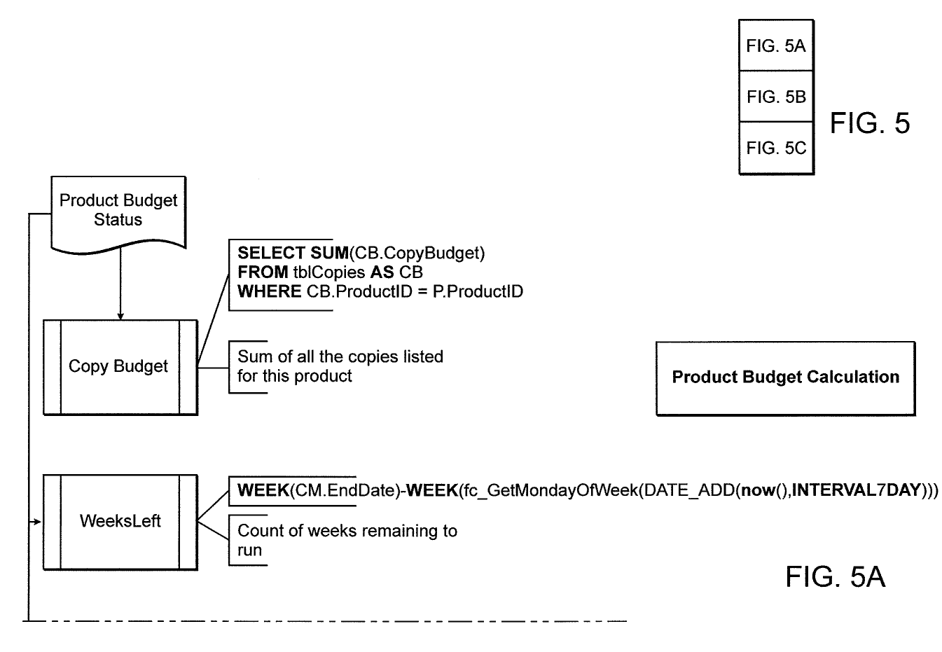

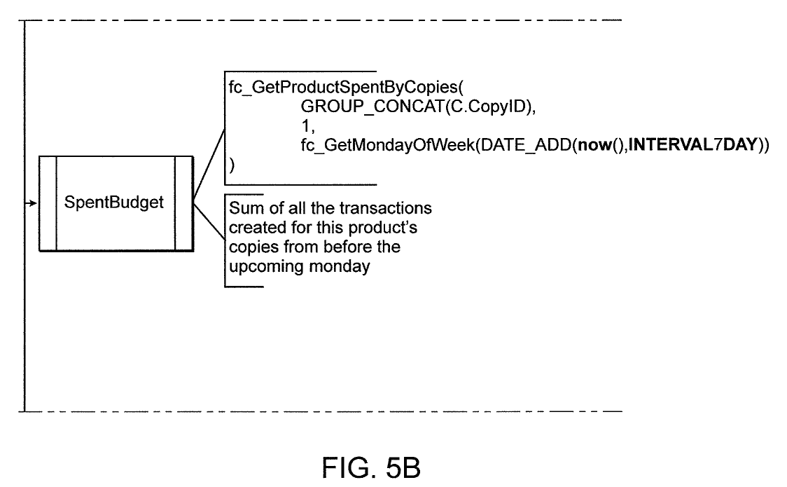

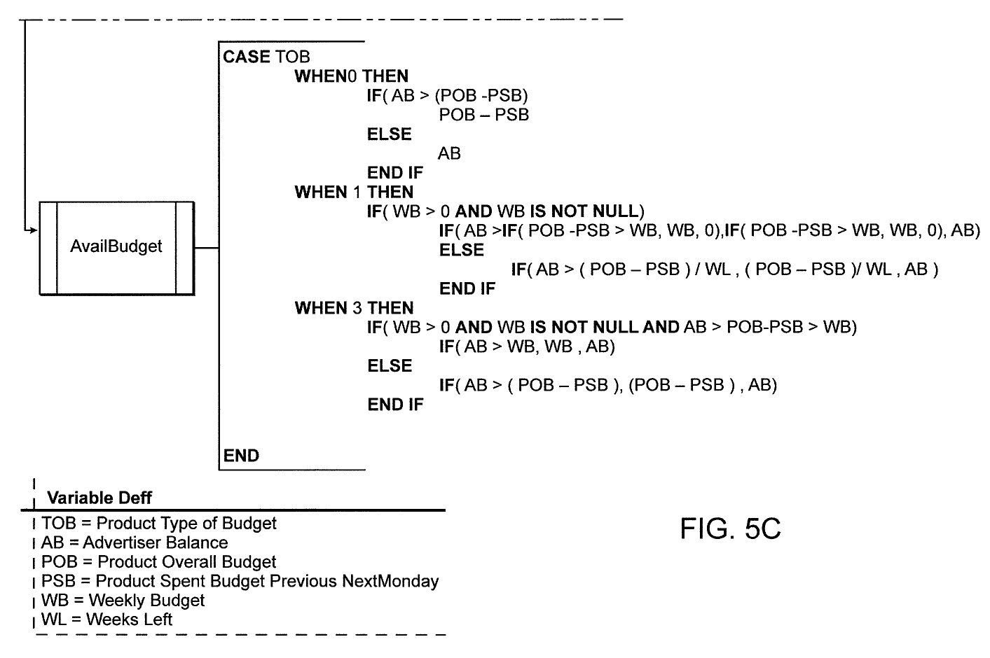

To determine budget distribution among several sites where advertisements are to be placed among more than one MSO, network, or station, the weights assigned to each broadcaster are used. For example, if the budget for a particular campaign for a given week is $5,000 and the weights given to three stations are % 50, % 30, and 20% then the budget, in some instances, is spent using $2,500, $1,500, and $1,000 to buy ad space on the respective networks. However, if the advertiser changes the budget for that campaign for the next week to $10,000, no additional information for the stations is necessary as the money available to place advertisements will automatically be allocated as $5,000, $3,000, and $2,000. One product budget calculation module provided by the technology to assist advertisers in setting a product budget is depicted in FIG. 5.

After the budget weight is calculated (step 230), an inventory weighting module allocates advertisements among the inventory using (step 235) advertiser site weights to determine preference (or lack thereof) for particular advertisers (thereby increasing the number of inventory slots available to a preferred advertiser). Using the weights of agency, account manager, advertiser, product and copy collected in their respective set ups, the inventory summary is utilized to assign spots based on the percentages for each copy for each network inside every syscode. Beneficially, this process decreases, or in some instances, eliminates the problem of multiple copies competing for a single spot.

Once the above is completed, orders are placed (step 240) by an order placement module. Typically before orders are placed, load values are verified.

| Value | Description |
|---|---|
| MaxLoopCount | This is the highest Max Spot required by any |
| | copy. |
| Balance | Total of money that the system is supposed to |
| | spend overall. |
| Running Balance | How much have we already spent for copies on |
| | the queue |

Typically the data from the inventory weighting process (step 235) is joined with the data from the DMA price check (step 215). This information is used to determine the amount of spots placed on each syscode and how much the difference of money was at the DMA level (step 215). Once the information is joined, the technology iterates automatically though every day part for every copy at the syscode level where the Difference of Rate at the DMA level is greater than zero. Specifically, (a) the budget information is examined and an order placing module determines how much this copy can spend on the current syscode. Secondly, (b) the order placing module determines if there is still a spot available from the Inventory Summary data. If (a) and (b) have data then the syscode is examined to determine if it has enough money for the new available spot. If the syscode does not have enough money then two options are available. If a line of credit exists, e.g., a “Piggy Bank”, and has enough money available, the money to purchase the advertisement for that time slot is purchased. If, however, the line of credit does not have enough money, then the syscode lends the remaining money to the line of credit. In some implementations, the “piggy bank” is not a line of credit per se, but is a temporary bank to hold remaining budget of any syscode. The piggy bank is used so the next sys-code that has no money can buy the last spot and spend the last few cents or dollars assigned to each copy.

If there are both money and spots available, the order placement module creates an order for every advertiser per every market. Each time the system places a spot, all the inventory and advertisement and budget data will be updated and the advertisement is appended to the respective advertiser and market. The technology iteratively and automatically repeats this process until all the money has been spent for all the syscodes.

After this process is done, the system determines each copy's remaining budget and reimburses the remaining balance to the advertiser via the accounting module for the next copy to use. The data generated by the order placement process (step 240) is then used to create the orders. In some embodiments the orders are in a proprietary format. In other implementations the orders are converted into an XML file and stored for history purposes.

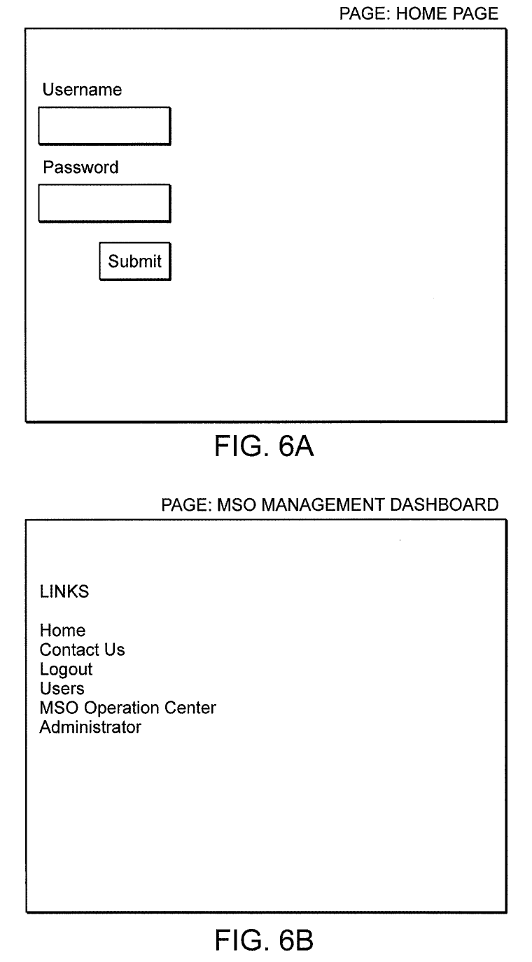

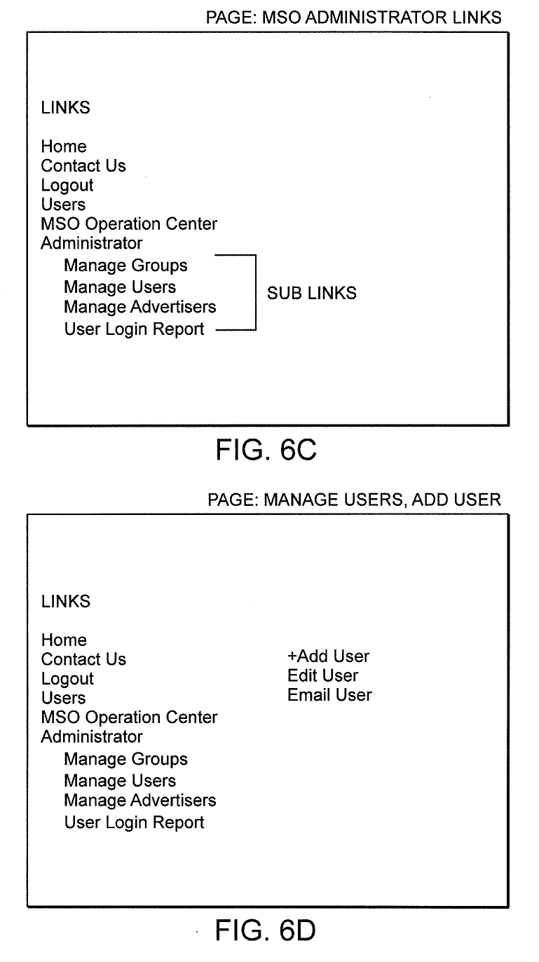

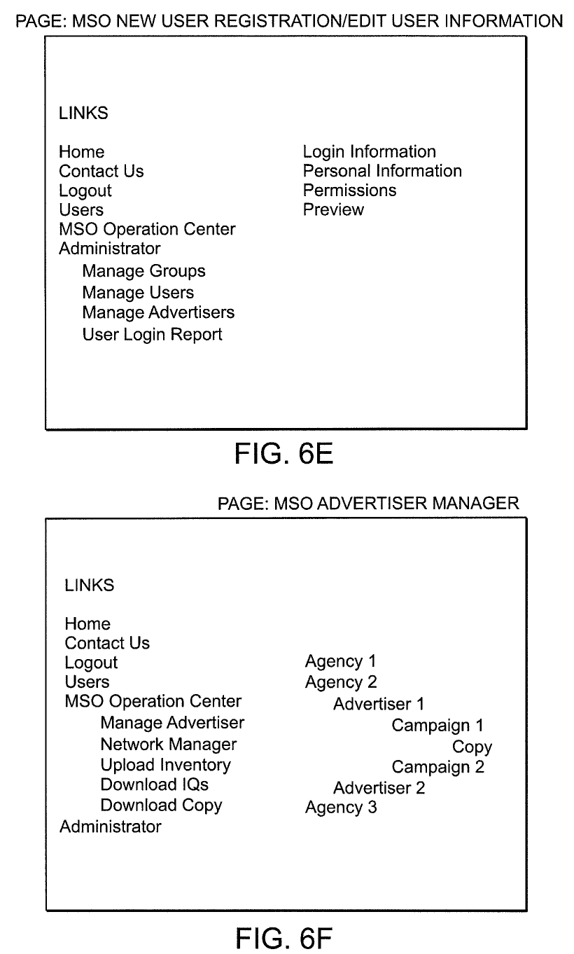

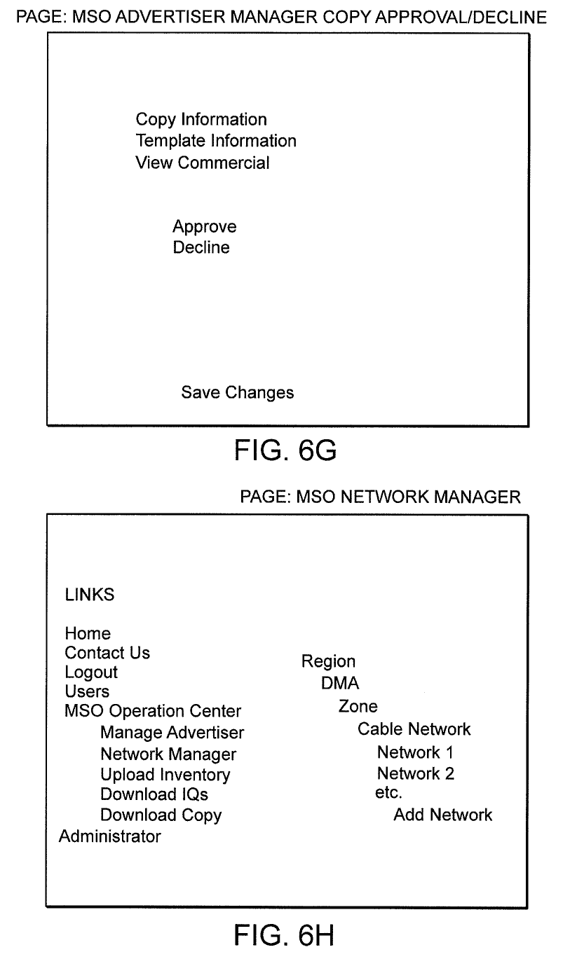

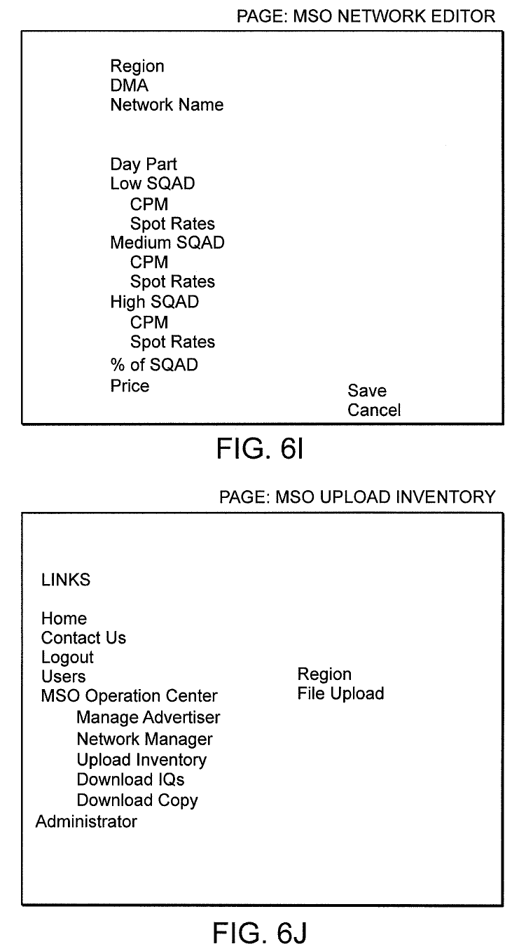

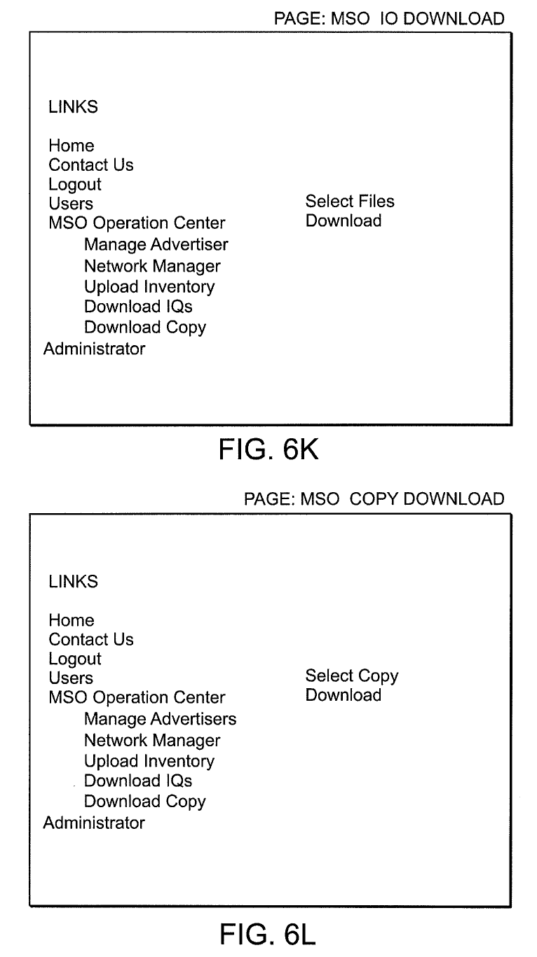

FIGS. 6A through 6L depict screenshots describing functionality available to a media seller in some implementations for the technology, whereby users can add, delete, and manage users, advertisers, and copy. The MSO is provided a username and password by the operators of SWMXTV. The MSO user accesses the system by submitting the username and password at the login screen (FIG. 6A). Upon acceptance of the username and password, the user is authorized and is presented a MSO dashboard page with hypertext links such as “Home”, “Contact Us”, “Logout”, “Users”, “MSO Operation Center”, and “Administrator” depicted in FIG. 6B. When an authorized user clicks on “Administrator”, the user is presented with an administrator's page (FIG. 6C) containing additional hypertext links such as “Manage Groups”, “Manage Users”, “Manage Advertisers”, and “User Login Report”. If user selects “Manage Users,” the user is presented page with functionality for managing users that can access the SWMX.com website.

On the Manage Users page depicted in FIG. 6D, if the user selects “Email User,” the user's default email application composes a new message to be sent to the recipient user. If user selects “+Add User” the user can create additional users for the MSO the user is associated with. If the user selects “Edit User,” the user is presented the Edit User page depicted in FIG. 6E. The user can then modify information for an existing user for the MSO. On the Add/Edit User page, the user can create new users or edit existing users. Examples of editable information include Login Information, Personal Information, and Permissions. The “Permissions” section enables the user to set which areas of SWMXTV the new/modified user can gain access to.

Referring to FIG. 6G, in some implementations, when a user selects “MSO Operation Center” from the navigation on the left the user is presented with additional links such as “Manage Advertisers”, “Network Manager”, Upload Inventory”, “Download IOs” and “Download Copy.” When a user selects “Manage Advertisers”, the user is able to approve or decline specific advertising on SWMXTV. By selecting “Manage Advertisers” the user is presented, in FIG. 6F, with all advertising agencies, advertisers, campaigns (and corresponding) copy that are seeking to purchase time slots of the MSO. The MSO is then able to approve or decline any copy that is presented to them by selecting “Copy”. During the approval/declining process the user is able to view copy information, template information, and the actual advertisement. The user then approves or declines the advertisement and is then able to view, approve/decline other advertisements. After making decisions on one, some, or all of the available advertisements, the user then saves their decisions by clicking “Save Changes.”

To manage specific cable networks and local zones, the MSO user selects “Network Manager” under “MSO Operations Center”. The Network Manager functionality is depicted in FIG. 6H. MSO users then are able to manage each network by Region, by Designated Market Area (DMA), and/or by Zone. For example, the user is able to “Add Networks” if the MSO starts to manage more networks in a Zone. The user is also able to edit Region, DMA, and Network name.

Additionally, in some implementations (depicted in FIG. I), the user can turn Day Parts on or off to accept advertisements based on day parts. A day part is a segment of time that divides a radio or television day for advertisement scheduling purposes. These segments generally reflect a television station's programming patterns. Some common day parts are: prime time, day time, late night, and early morning. The user can also select Low, Medium, or High SQAD to establish what the desired pricing for a given time slot is based on. SQAD is a 3rd Party data provider which provides CPM estimated pricing by Market. The user can set the percentage the MSO is willing to accept for the spots based on the criteria listed above. The desired price for the slot is then calculated based on a formula of all of the above selected information. Once all data has been filled in, the user selects “Save” to save the data.

In FIG. 6J, under “MSO Operations Center” the user is also able to upload available time slot information to SWMXTV. The user selects “Upload Inventory” and is prompted to provide a region and an upload file. Once file is uploaded, SWMXTV then processes the file, parsing the available inventory from the upload inventory file. SWMXTV then runs a matching script to determine which advertisements are given back to the MSO in the form of an insertion order (IO).

Under “MSO Operations Center”, in FIG. 6K, the user is also able to download insertion orders by selecting “Download IO”. An Insertion Order is a broadcast agreement between the television station and the advertiser reduced to writing. Also Under “MSO Operations Center”, in FIG. 6L, the user is also able download specific advertisements by selecting “Download Copy”. Copy is typically provided as an actual commercial to run on air in a MPEG-2 movie formation or “.MOV” file format. Other formats, however, may also be used, e.g., MPEG-4, DIVX, AVI, H.264, and the like.

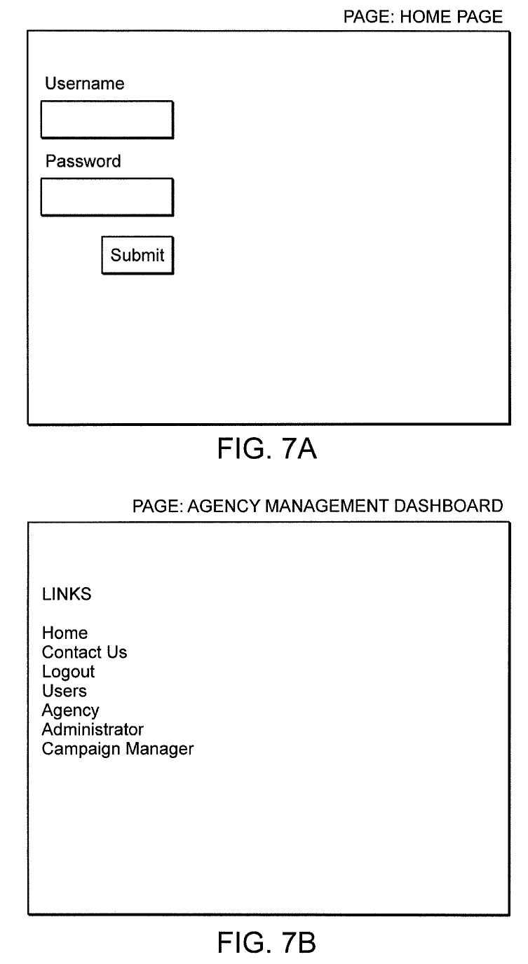

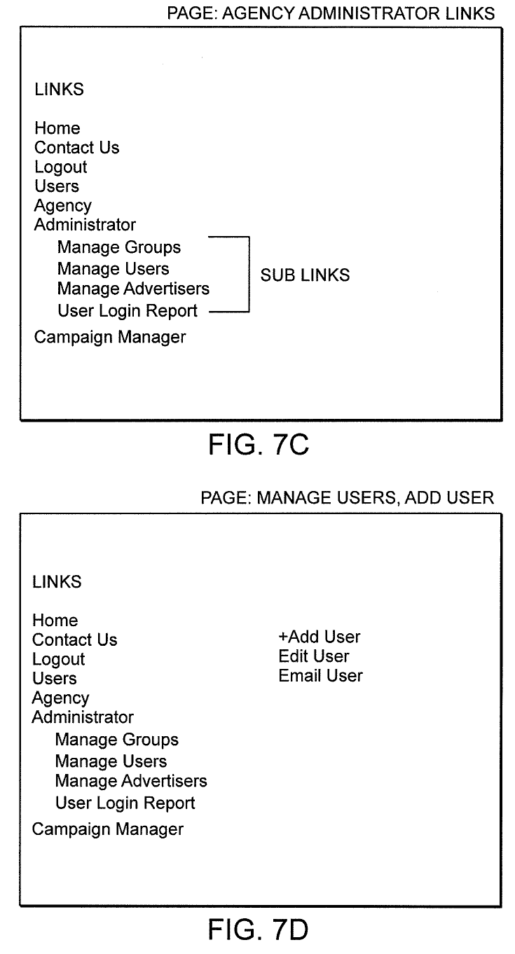

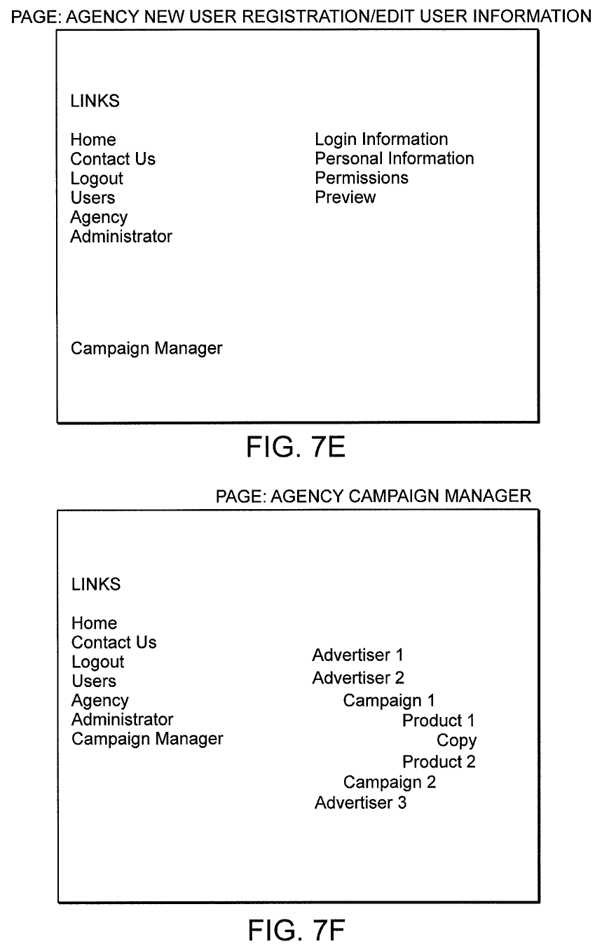

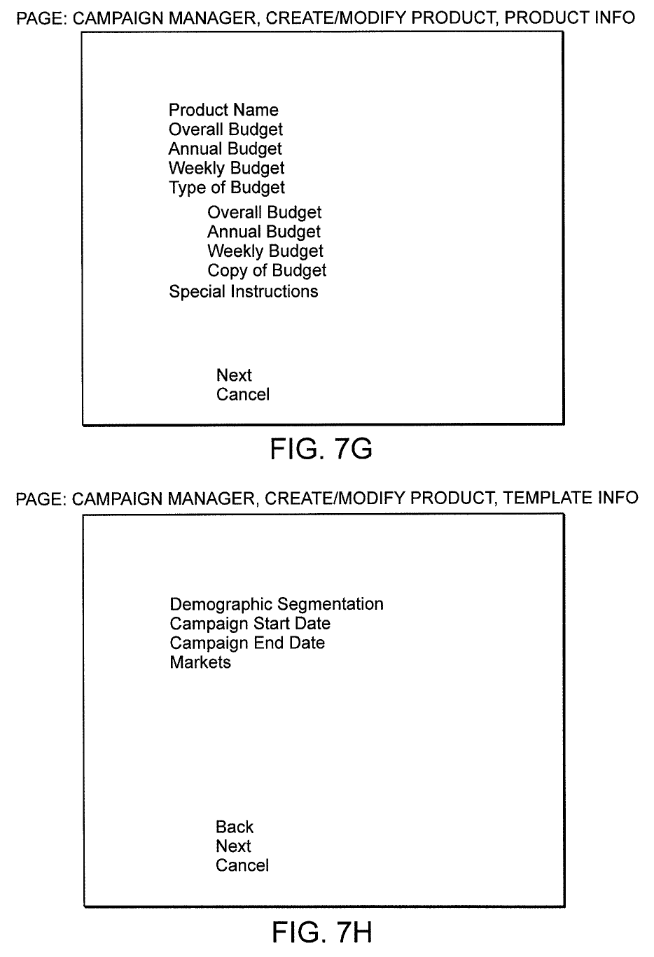

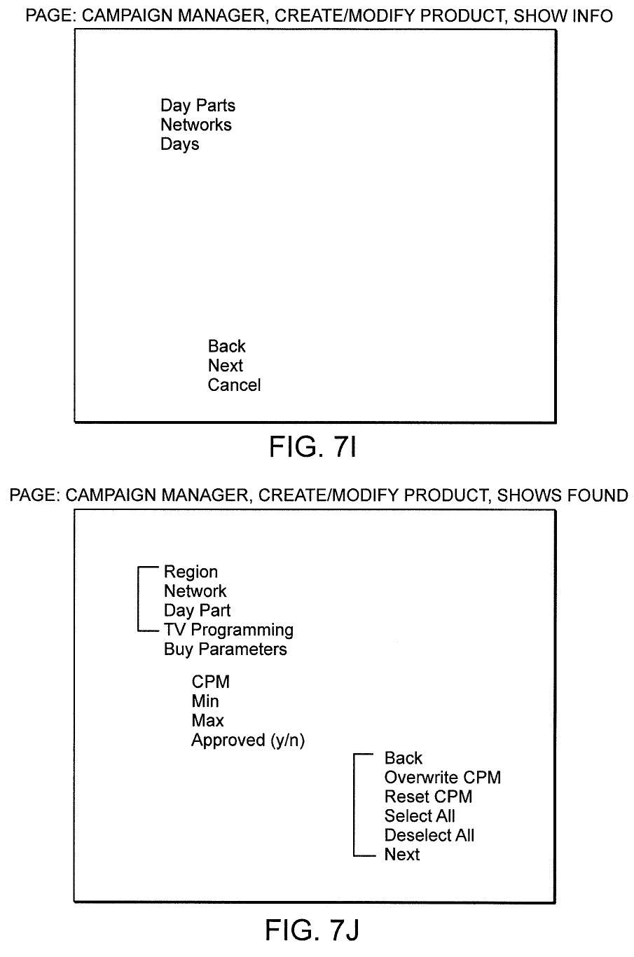

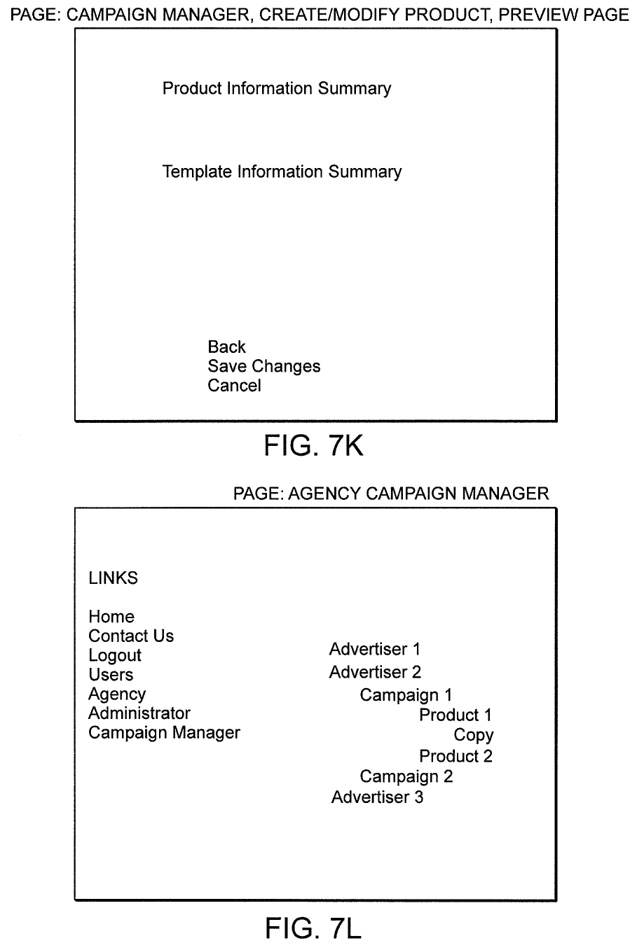

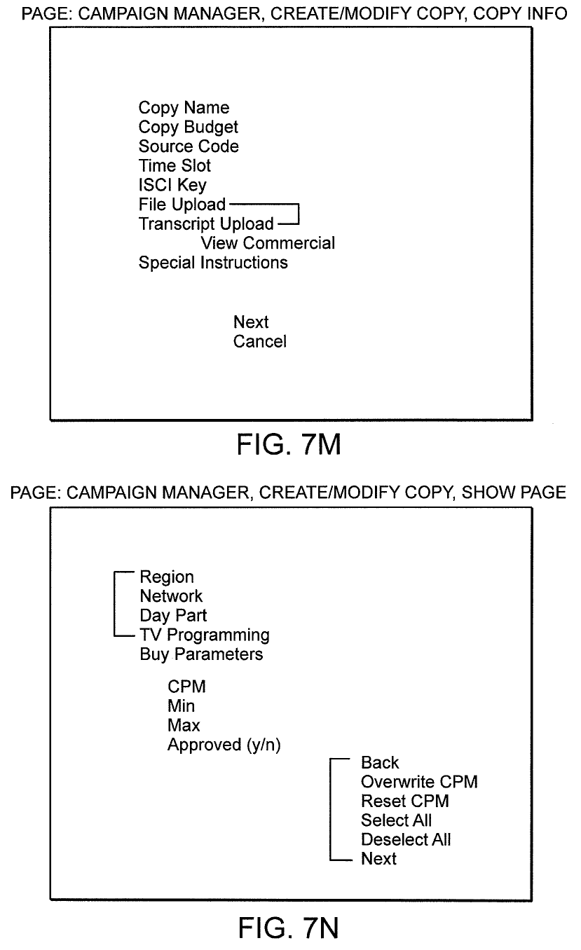

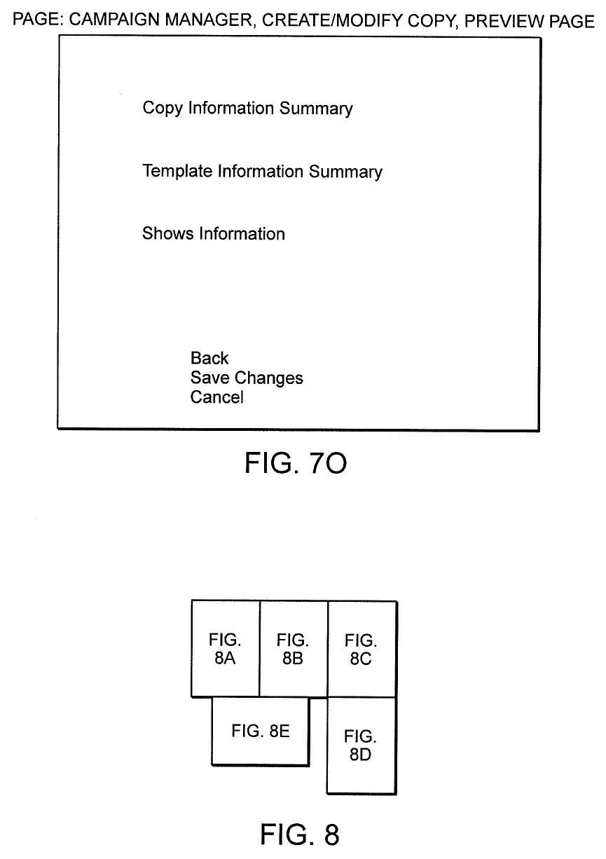

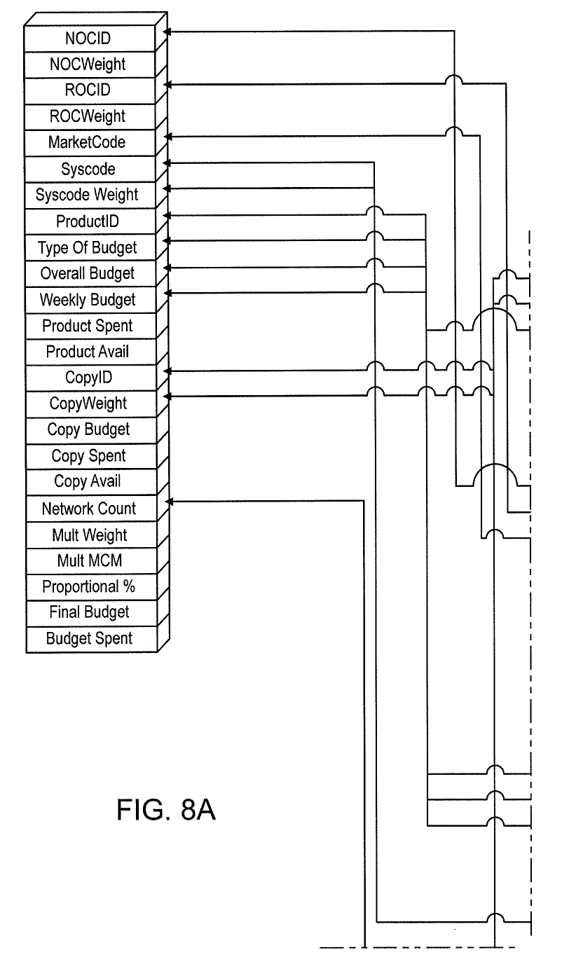

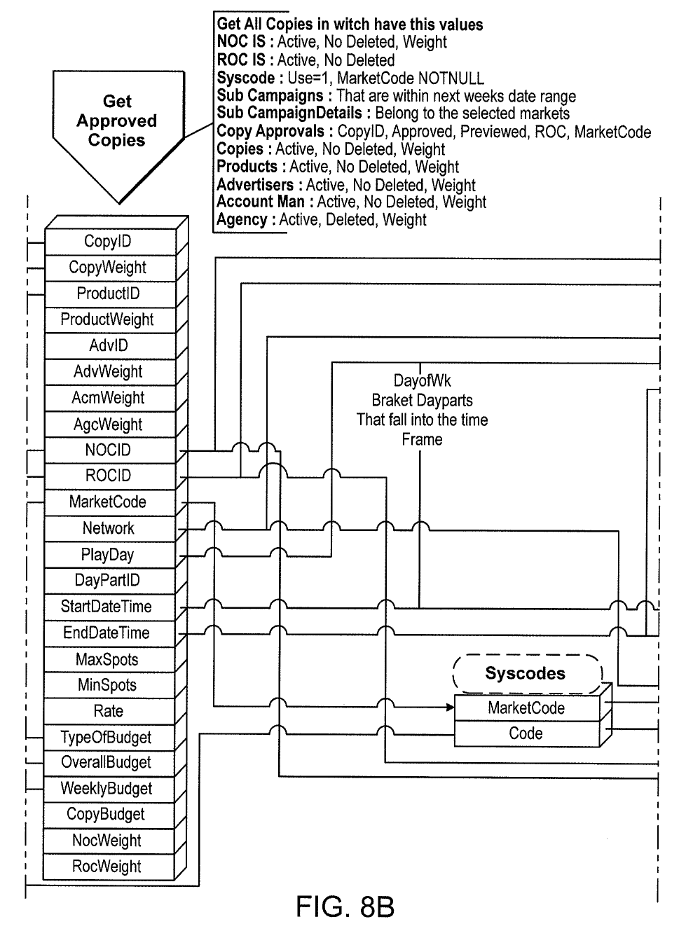

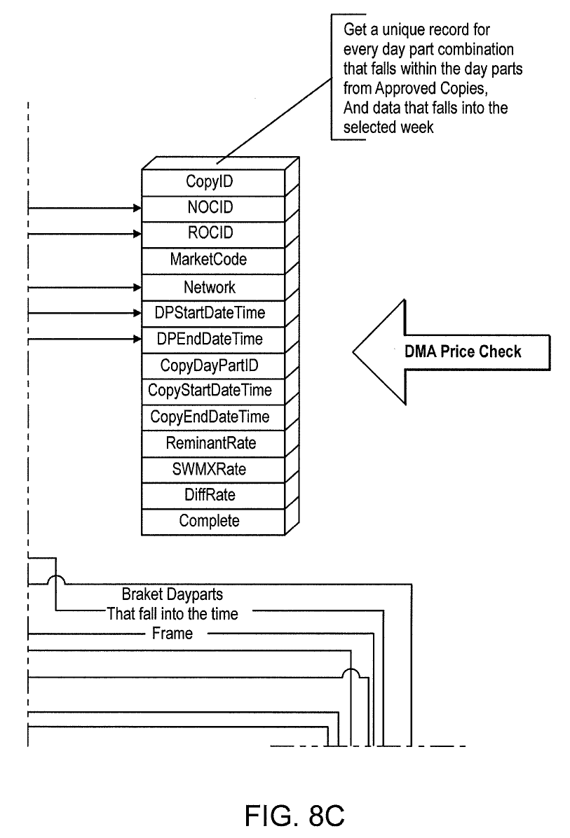

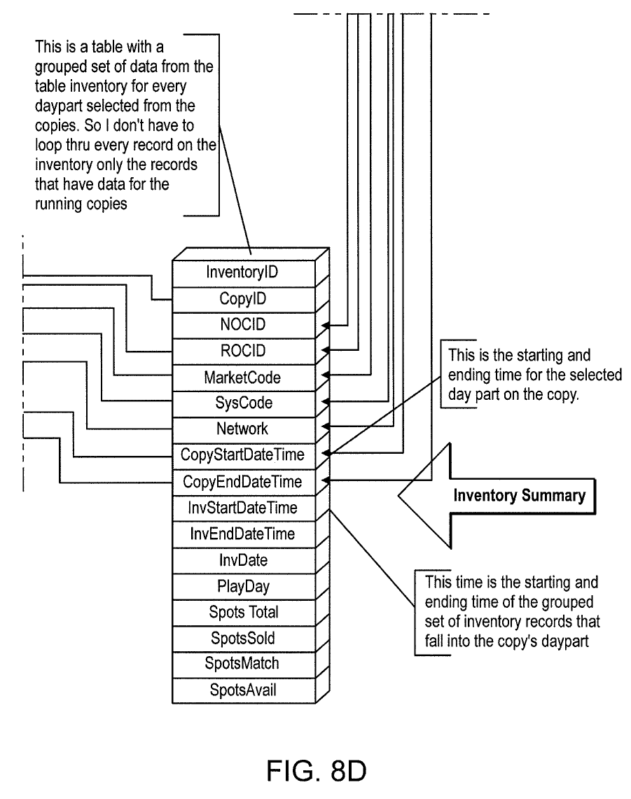

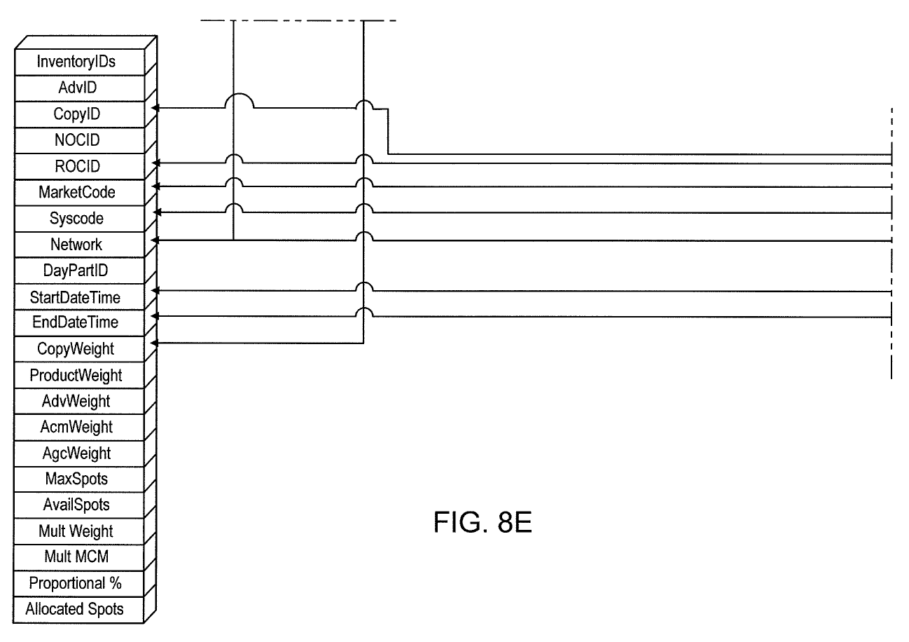

FIGS. 7A through 7O depict screenshots describing functionality available to an advertiser in some implementations for the technology, whereby users can add, delete, and manage users, advertisers, and copy. The advertiser user is provided a username and password by the operators of SWMXTV. The user accesses the system by submitting the username and password at the login screen (FIG. 7A). Upon acceptance of the username and password, the user is authorized and is presented an agency dashboard page with hypertext links such as “Home”, “Contact Us”, “Logout”, “Users”, “Agency”, “Administrator”, and “Campaign Manager” depicted in FIG. 7B. When an authorized user clicks on “Administrator”, the user is presented with an administrator's page (FIG. 7C) containing additional hypertext links such as “Manage Groups”, “Manage Users”, “Manage Advertisers”, and “User Login Report”. If user selects “Manage Users,” the user is presented page with functionality for managing users that can access the SWMX.com website.

On the Manage Users page in FIG. 7D, if the user selects “Email User,” the user's default email application composes a new message to be sent to the recipient user. If user selects “+Add User” the user can create additional users for the MSO the user is associated with. If the user selects “Edit User,” the user can modify information for an existing user for the MSO. On the Add/Edit User page, the user can create new users or edit existing users. The Edit User page is depicted in FIG. 7E. Examples of editable information include Login Information, Personal Information, and Permissions. The “Permissions” section enables the user to set which areas of SWMXTV the new/modified user can gain access to.

In FIG. 7F, when an advertiser user selects “Campaign Manager”, they are able to create/edit advertising campaigns on SWMXTV. Once “Campaign Manager” is selected, all Advertisers are listed. A user can then select a specific Advertiser or add a new Advertiser. If an existing Advertiser is selected, Campaigns which have been created can be edited or new Campaigns can be added. If an existing Campaign is selected, Products (specific advertisements) which have been created can be edited or new Products can be added. Additionally, Copy for a specific spot can be edited or added for a Product.

When user selects Create or Modify Product, the user is guided to the Product Information page (FIG. 7G), where, through a series of steps, the user provides information for the Product such as “Product Name”, “Overall Budget”, “Annual Budget”, “Weekly Budget”, “Type of Budget”, “Copy Budget” and/or any “Special Instructions”. Selecting “Type of Budget” allows the user to set the parameters for how the budget is to be spent. When the information is set, the user either selects “Next” or can cancel the update/addition. Selecting “Next” takes the user to a Template Information page.

FIG. 7H depicts a Template Information page, where the user sets the demographic information desired for the Campaign. SWMXTV utilizes Demographic and Market data to cross reference with Nielsen Ratings Data to establish pricing for a specific advertisement spot on SWMXTV. When the information is set, the user clicks on “Back” or “Next” or the user can cancel the info. Selecting “Back” takes the user to the Product Information page. Selecting “Next” takes the user to the Show Information page.

On the Show Information page (FIG. 7I) the user can set their Day Parts, Cable Networks, Days of the week. The user can then select “Back”, “Next” or “Cancel”. By clicking “Next” the Campaign information is submitted. Upon submission of the Campaign Information, SWMX cross-references the Demographics, Markets, Day Parts, Networks, and Days with the Nielsen Ratings Data and Television Programming Data to present potential buying information to the user on a “Shows Found” page.

Referring to FIG. 7J, on the “Shows Found” page the user sets their Buy Parameters including the CPM, Minimum and Maximum Spots per Day Part, and whether to approve this specific criteria to run. Based on information on Acceptable CPM Rates provided by the Media Entity, a suggested CPM is listed. The user can then Overwrite the CPM presented, Reset the CPM presented or select Next to accept the parameters as-is and continue.

Continuing from the “Shows Found” page (FIG. 7J), the user is then presented with a Preview Page (FIG. 7K) where Product Information and Template Information are summarized. The user can make revisions to the entered information, Save Changes, or the user can select Cancel. If Save Changes is selected, the User returns to the Campaign Manager page (FIG. 7L).

Referring to FIG. 7M, once a product is created, specific copy (the actual advertisement) can be attributed to the product. A user can add new copy or edit existing copy associated with a product via the advertiser dashboard. The user enters information such as “Copy Name”, “Copy Budget”, “Source Code”, “Time Slot”, “ISCI Key” (i.e., an identification code given to a particular commercial to be used as a reference when pushing the commercial to a traffic or order fulfillment system at the MSO), “Special Instructions” as well as uploading a file for

the advertisement or a transcript. By specifying “Upload File”, the user uploads the advertisement to SWMXTV servers. In some implementations the file is an MPEG (Moving Picture Experts Group) movie file. In some embodiments, the MPEG file is converted to a Macromedia Flash file for presentation back to the user. After uploading and/or conversion, the user can preview the advertisement. Once the user is satisfied with the advertisement, the user selects Next or Cancel.

Referring to 7N, similar to the functionality that applies to entire campaigns described in reference to FIG. 7J information such as CPM, Minimum and Maximum Spots per Day Part, and whether to approve this specific criteria to run can be applied to an individual advertisement under the campaign. Beneficially, this enables an advertiser or agency to target/price specific criteria within a campaign. As before, the user can then Overwrite the CPM presented, Reset the CPM presented or select Next to accept the parameters as-is and continue to the Preview Page.

On the Preview Page copy (FIG. 7O), information and template information are summarized. The user can revise any of this information. Additionally, shows information summarizes the Market, Network, Day Part, Spot Frequency (MiniMax), CPM Offered, and Spot Pricing. The pricing algorithm is based on a formula that factors in Nielsen Data by Market. It then can generate value based information that can be used by the advertiser to determine the value they are receiving for the spot. The Information can be viewed as a CPM (cost per thousand viewers), CPP (Cost Per rating Point), GRP (Gross Rating Points that the spot is potentially going to deliver based on historical Nielsen information), Impressions (the overall extrapolated number of viewers supplied by Nielsen), Share (overall share of the market for the time slot or show receives) and HUT/PUT (known as projections where “Homes using Television/People using Television”). These columns can be dynamically set to view the information as desired by the advertiser to make an informed decision. The user can revise the information, save any changes made or cancel. If Save Changes is selected, the user returns to the Campaign Manager.

The above-described techniques can be implemented in digital electronic circuitry, or in computer hardware, firmware, software, or in combinations of them. The implementation can be as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps can be performed by one or more programmable processors executing a computer program to perform functions of the invention by operating on input data and generating output. Method steps can also be performed by, and apparatus can be implemented as, special purpose logic circuitry, e.g., an FPGA (field programmable gate array) or an ASIC (application-specific integrated circuit). Modules can refer to portions of the computer program and/or the processor/special circuitry that implements that functionality.

Processors suitable for the execution of a computer program include, by way of example, both general and special purpose microprocessors, and any one or more processors of any kind of digital computer. Generally, a processor receives instructions and data from a read-only memory or a random access memory or both. The essential elements of a computer are a processor for executing instructions and one or more memory devices for storing instructions and data. Generally, a computer also includes, or be operatively coupled to receive data from or transfer data to, or both, one or more mass storage devices for storing data, e.g., magnetic, magneto-optical disks, or optical disks. Data transmission and instructions can also occur over a communications network. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special purpose logic circuitry.

To provide for interaction with a user, the above described techniques can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer (e.g., interact with a user interface element). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The above described techniques can be implemented in a distributed computing system that includes a back-end component, e.g., as a data server, and/or a middleware component, e.g., an application server, and/or a front-end component, e.g., a client computer having a graphical user interface and/or a Web browser through which a user can interact with an example implementation, or any combination of such back-end, middleware, or front-end components. The components of the system can be interconnected by any form or medium of digital data communication, e.g., a communication network. Examples of communication networks include a local area network (“LAN”) and a wide area network (“WAN”), e.g., the Internet, and include both wired and wireless networks.

The computing system can include clients and servers. A client and server are generally remote from each other and typically interact through a communication network. The relationship of client and server arises by virtue of computer programs running on the respective computers and having a client-server relationship to each other.

The invention has been described in terms of particular embodiments. The alternatives described herein are examples for illustration only and not to limit the alternatives in any way. The steps of the invention can be performed in a different order and still achieve desirable results. Other embodiments are within the scope of the following claims.

I claim:

1. A method for matching television advertisements to unused television advertising space comprising:
receiving, from an advertiser, a television advertisement, a price offered associated with the advertisement, and a first rate-determinative data;
receiving, from a television station, a time slot that has not yet been sold, an asking price associated with the time slot, and a second rate-determinative data;
matching the advertisement with the time slot based on a weighted budget based on the time slot, the offered price, the asking price, and a comparison between the first rate-determinative data and the second rate-determinative data; and
sending a confirmation to the advertiser and a traffic data to the television station comprising the advertisement and the time slot.

2. The method of claim 1 wherein the confirmation comprises at least one of ratings information, show information, date and/or time information related to running the commercial, price, length of commercial unit, or any combination thereof.

3. The method of claim 1 wherein the first and second rate-determinative each comprise one or more of a number of impressions, a geographic location, a CPM value, a television show, a television channel, a television network, a day part, or any combination thereof.

4. A system for matching television advertisements to unused television advertising space comprising:
A first computer server configured to:
receive, from an advertiser, a television advertisement, a price offered associated with the advertisement, and a first rate-determinative data;
receive, from a television station, a time slot that has not yet been sold, an asking price associated with the time slot, and a second rate-determinative data;
match the advertisement with the time slot based on a weighted budget based on the time slot, the offered price, the asking price, and a comparison between the first rate-determinative data and the second rate-determinative data; and
send a conformation to the advertiser and a traffic data to the television station comprising the television advertisement and the time slot.

5. The system of claim 4 wherein confirmation comprises at least one of ratings information, show information, date and/or time information related to running the commercial, price, length of commercial unit, or any combination thereof.

6. The system of claim 4 wherein the first and second rate-determinative each comprise one or more of a number of impressions, a geographic location, a CPM value, a television show, a television channel, a television network, a day part, or any combination thereof.

7. The system of claim 4 wherein the computer server is a plurality of computer servers.

8. A computer program product, tangibly embodied in a computer-readable medium, for matching television advertisements to unused television advertising space, the product comprising instructions operable to cause a data processing apparatus to:
receive, from an advertiser, a television advertisement, a price offered associated with the advertisement, and a first demographic data;
receive, from a television station, a time slot that has not yet been sold, an asking price associated with the time slot, and a second demographic data;
match the advertisement with the time slot based on a weighted budget based on the time slot, the offered price, the asking price, and a comparison between the first rate-determinative data and the second rate-determinative data; and
send a conformation to the advertiser and a traffic data to the television station comprising the television advertisement and the time slot.

9. The computer program product of claim 8 wherein confirmation comprises at least one of ratings information, show information, date and/or time information related to running the commercial, price, length of commercial unit, or any combination thereof.

10. A method for matching advertisement copy to unused advertising inventory of a television station comprising:
receiving a first parameter associated with the copy from an advertiser;
receiving a second parameter associated with the inventory;
determining a designated market area price check;
summarizing the inventory of the television station;
determining a budget associated with the copy based on the first parameter;
determining a first weighted value associated with the television station based on the second parameter;
determining a second weighted value associated with the television station based on the budget;
determining a third weighted value associated with the inventory based on the second weight; and
matching the copy with the inventory based on the first and third weighted values.

11. The method of claim 10 wherein the television station is at least one of a plurality of television stations, a regional operator, or a multi-system operator.

12. The method of claim 11 wherein the matching step is performed iteratively and automatically for the television station.

13. The method of claim 10 wherein the first parameter is a price offered to display the copy at a particular time.

14. The method of claim 10 wherein the second parameter is a price requested to display the copy at a particular time.

15. A system for matching advertisement copy to unused advertising inventory of a television station comprising:
A computer server configured to:
receive a first parameter associated with the copy from an advertiser;
receive a second parameter associated with the inventory;
determine a designated market area price check;
summarize the inventory of the television station;
determine a budget associated with the copy based on the first parameter;
determine a first weighted value associated with the television station based on the second parameter;
determine a second weighted value associated with the television station based on the budget;
determine a third weighted value associated with the inventory based on the second weight; and
match the copy with the inventory based on the first and third weighted values.

16. The system of claim 15 wherein the computer server is a plurality of computer servers.

17. A computer program product, tangibly embodied in a computer-readable medium, for matching advertisement copy to unused advertising inventory of a television station, the product comprising instructions operable to cause a data processing apparatus to:
receive a first parameter associated with the copy from an advertiser;
receive a second parameter associated with the inventory;
determine a designated market area price check;
summarize the inventory of the television station;
determine a budget associated with the copy based on the first parameter;
determine a first weighted value associated with the television station based on the second parameter;
determine a second weighted value associated with the television station based on the budget;
determine a third weighted value associated with the inventory based on the second weight; and
match the copy with the inventory based on the first and third weighted values.
